(19) United States
(12) Patent Application Publication
(10) Pub. No.: US 2005/0243990 A1
(43) Pub. Date: Nov. 3, 2005

(54) Method and apparatus for pre-arranging telephone connections between identifiable parties

(76) Inventor: W.J.K. Herwegh Vonk, Waresley Grange (GB)

Correspondence Address: BAKER & MCKENZIE LLP, 805 THIRD AVENUE - 29TH FLOOR, NEW YORK, NY, 10022, US

(21) Appl. No.: 10/834,334

(22) Filed: Apr. 28, 2004

(51) Int. Cl. H04M 3/42

(52) U.S. Cl. 379/210.01; 379/211.01

(57) ABSTRACT

A system and method for pre-arranging telephone connections between identifiable parties is provided. A personal telephone includes an auto-rescheduling module, a resident directory, and a resident diary. When a call is received and the called party is not available, the auto-rescheduling module automatically checks the caller's identification in the resident directory. If the caller's identification exists in the resident directory, the auto-rescheduling module automatically consults the resident diary for the next available time and provides the next available time to the caller to automatically reschedule the call.

### TECHNICAL FIELD

The present application relates to personal telephone communications, and more particularly, to a method and system for automatically scheduling responses to calls where the called party is unavailable.

### BACKGROUND

Many telephone calls are left unanswered or missed, because, for example, the called party is unable to pickup the phone, the phone is turned off, or otherwise unavailable. Some of these phone calls are from persons unknown to the called party, such as telemarketers, wrong numbers, etc., and as such, the called party may not desire to return the call, or may desire to actively block or ignore such calls.

Other calls that are unanswered or missed are from persons that the called party would like to hear from, for example, for personal or business reasons. In this case, a called party may attempt to return the call at the called party's convenient time. However, returning a call at the called party's convenient time does not guarantee that the called party will get in contact with the calling party, since, at that time, the calling party may not be available.

Accordingly, what is needed is a system and method for effectively screening out undesirable calls, while being able to automatically reschedule unanswered desirable calls at a mutually convenient time for the callers and called parties.

### SUMMARY

A system and method for pre-arranging telephone connections between identifiable parties is provided. The method in one aspect includes receiving a telephone call from a caller, if a called party is not available, automatically determining if the caller is recognizable, and automatically attempting to arrange a time for a next telephone call if the caller is recognizable.

A caller may be recognizable if the caller's identification, for example, the caller's telephone number, is found in a directory resident in a telephone of the called party. In one aspect, to automatically arrange a time for a next telephone call, a diary resident in the called party's telephone is consulted for the called party's schedule. An available time found in the called party's schedule is then provided to the caller and the caller is given an option to reschedule the call at that time. If the caller agrees, a call is automatically rescheduled.

A system for pre-arranging a telephone connection between identifiable parties in one aspect includes a directory, a diary, and an auto-scheduling module resident in a telephone. The directory includes at least one or more telephone numbers. The diary has a schedule of a user of the telephone. The auto-scheduling module is operable to receive a call from a caller and automatically identify the caller, and if the caller is identified as being in the directory, the auto-scheduling module is operable to determine a next available time from the diary and to provide the next available time for re-scheduling the call.

In one embodiment, the directory may be separated into a plurality of sections. At least one of the sections includes the telephone or identification numbers of those with whom the called party would like the call to be automatically rescheduled. Other sections may include telephone numbers listed for reference purposes only.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a flow diagram illustrating a method of pre-arranging telephone connection between identifiable parties in one embodiment.

FIG. 2 is a flow diagram illustrating a method of pre-arranging telephone connections in one embodiment when the called party's phone has auto-scheduling capability.

FIG. 3 is a flow diagram illustrating a method of pre-arranging telephone connections in one embodiment when both parties' phones have auto-scheduling capability.

FIG. 4 is a block diagram illustrating the system architecture for pre-arranging telephone connections between identifiable parties in one embodiment.

FIG. 5 is a block diagram illustrating the system architecture for pre-arranging telephone connections between identifiable parties in another embodiment.

### DETAILED DESCRIPTION

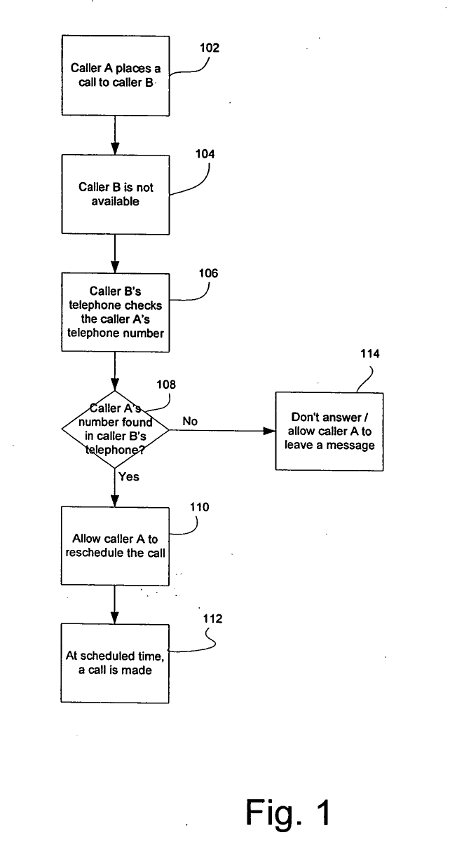

FIG. 1 is a flow diagram illustrating a method of pre-arranging telephone connection between identifiable parties in one embodiment. At 102, caller A places a call to caller B. If caller B is not available to answer the call, for example, as shown at 104, caller B's phone is busy, or otherwise unavailable to answer the call, caller B's phone checks the caller A's telephone number for identification. Alternatively, this checking may occur, for example, if caller B's phone is not answered after a predetermined number of rings or predetermined amount of time.

Caller B's phone may, for example, be programmed to check the caller identification or phone number of caller A. In one aspect, caller B's phone includes a directory of phone or identification numbers that caller B already knows. Accordingly, at 106, caller B's phone checks the caller A's identification and determines whether the caller A's identification exists in the caller B's phone directory.

In another aspect, caller B's directory resident in caller B's telephone may be divided into two sections. The first section may include those caller identifications or telephone numbers that caller B would like the telephone to automatically re-schedule the time of the call. The second section may include those caller identifications or telephone numbers that caller B keeps for reference, but would not like to automatically schedule calls that were not answered. In this aspect, caller B's telephone provides an option to automatically reschedule the call to caller A, only if caller A's identification is found in the first section of caller B′ directory.

At 108, if caller A's telephone number, or optionally an identification number, is found in the caller B's phone directory as one of the numbers permitted for automatic scheduling, the caller B's telephone provides caller A with the option to plan a telephone call with caller B at a time convenient to each of the callers as shown at 110. For instance, caller B's phone may include a diary which has a list of schedules for caller B. Caller B's telephone consults this diary to determine the time caller B is available. This may be the next available time specified in the diary for a given day. Consequently, caller B's telephone provides caller A with an option to reschedule the call at that next available time. If caller A agrees, the call is then scheduled for that time.

At 112, a call is automatically placed to connect caller A and caller B. In one embodiment, caller B's telephone may be automatically programmed to call caller A's telephone at the scheduled time. Alternatively, caller A's telephone may be automatically programmed to call caller B's telephone at the scheduled time.

In another embodiment, the number of people involved in the call may be more than two, for example, as in a conference call. In this embodiment, a call will be placed to each of the people involved in the call at the scheduled time. At 114, if caller A's telephone number or identification is not in the caller B's directory, normal telephone call processing takes place.

In yet another embodiment, caller B's telephone may be programmed to block other incoming calls during and around the time of the scheduled call for a predetermined amount of time to ensure that the telephone is free at the scheduled return call time. For example, if a call is scheduled for a certain time of a day, all incoming calls may be blocked starting 30 or 60 seconds before that scheduled time to 30 or 60 seconds after that scheduled time. In addition, if the telephone is in use or an attempt is made to call another number within this period, the telephone may be programmed to alert the user of the telephone (e.g., caller B) that a call has been scheduled for that time and the scheduled re-call is imminent.

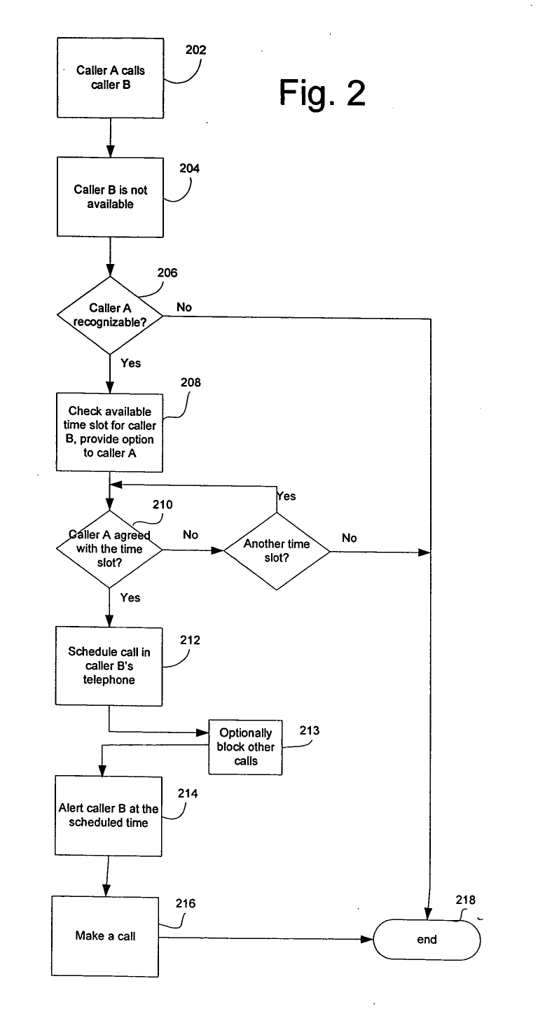

FIG. 2 is a flow diagram illustrating a method of pre-arranging telephone connections in one embodiment when the called party's phone has auto-scheduling capability. At 202, caller A calls caller B. At 204, caller B is not available. At 206, caller B's telephone determines whether it recognizes caller A's telephone number. Caller B's telephone may recognize caller A's telephone number, for example, if caller A's number is among the names and numbers in caller B telephone's resident database. Caller A's number will most likely be in caller B's telephone database, if caller A and caller B are regularly calling each other, for example.

At 208, if caller B's telephone recognizes caller A, then B's telephone checks caller B's next available time slot by, for instance, consulting a diary resident in caller B's telephone, and provides a message to A, such as “Hello caller A, caller B is sorry he is not available—would you like caller B to return your call today at X hours?” At 210, if caller A responds in the affirmative, for example, by saying “yes” or pressing a “1” key for yes, the slot agreed with caller A is automatically blocked so that the next caller cannot book the same time slot at 212.

If at 210, caller A does not agree to the offered time slot, caller A is provided with an option to schedule at another available time slot or to terminate the call at 211. If caller A accepts to schedule for another available slot, the process repeats at 210, otherwise, the call is terminated at 218.

At 214, caller B's telephone beeps at the agreed time to remind caller B to call caller A. Optionally, at 215, other calls occurring within a predetermined period of time that includes the scheduled call time may be blocked. Further, if an attempt is made to use the telephones at that time, the telephones may alert the respective users of the imminent scheduled call. At 216, if caller B approves, caller B's telephone automatically dials caller A's telephone number. At 218, the call ends.

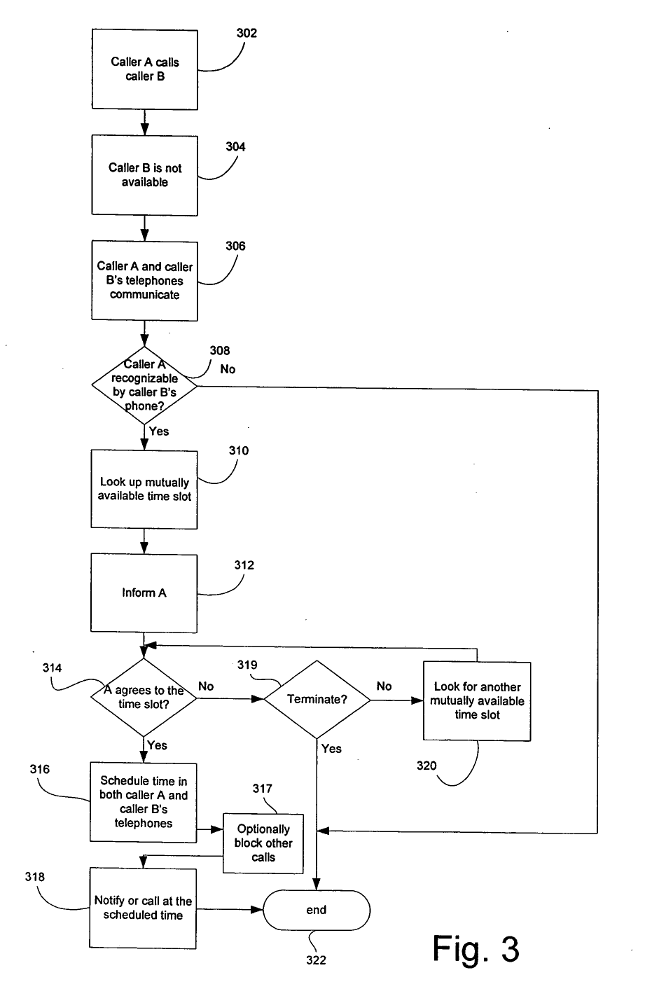

FIG. 3 is a flow diagram illustrating a method of pre-arranging telephone connections in one embodiment when both parties' phones have auto-scheduling capability. In this embodiment, caller A and caller B both have the auto-scheduling feature in their telephones, such as cellular mobile phones. At 302, caller A calls caller B. At 304, caller B is not available. At 306, caller A and caller B's telephones immediately communicate and caller B's telephone determines whether caller A's telephone number is recognizable, for example, by consulting its resident telephone directory. At 308, if the telephone number is recognizable, caller A and caller B's telephones automatically look for the first available mutually convenient time slot at 310, for instance, on that same day, without any action on the part of caller A. Available times may be determined, for instance, by consulting the diaries resident in the respective telephones of caller A and caller B.

At 312, when a mutually available time slot is found, caller A's telephone informs caller A of the mutually available time. At 314, A is provided with an option to use this available time slot to call caller B. At 316, if A agrees with the time, A may block that time slot in both telephones' diaries. At 318, if caller A agreed to the time slot for the call to be placed to caller B, caller A's telephone automatically calls caller B's telephone at the agreed time.

Optionally at 317, other calls occurring within a predetermined period of time that includes the scheduled call time may be blocked. Further, if an attempt is made to use the telephones at that time, the telephones may alert the respective users of the imminent scheduled call.

At 314, if caller A does not agree with the available time slot, at 320, caller A has an option to intervene and stop the communication process between the telephones at 319, or to have the telephones look up another mutually available time. At 320, caller A may also request caller B's telephone to look for another convenient time slot, for instance, on the same day, next day, or any other day. At 322, normal telephone call processing takes place, for example, after the call is made at 318, or terminated at 319.

In another embodiment, the automatic scheduling may begin without consulting caller A only if caller B's telephone identification is also found in caller A's directory.

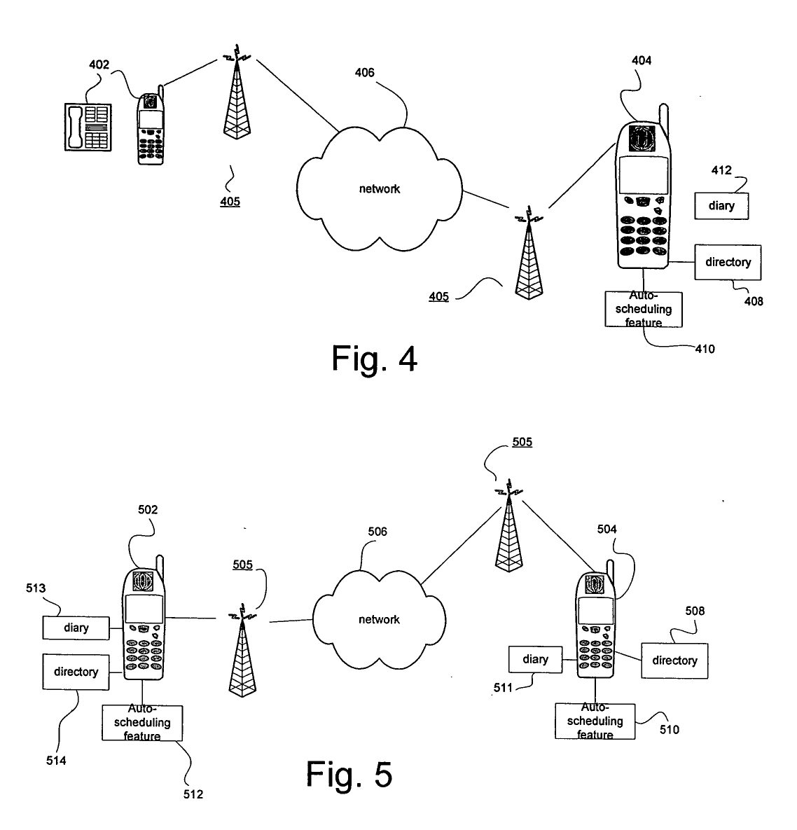

FIG. 4 is a block diagram illustrating the system architecture for pre-arranging telephone connections between identifiable parties in one embodiment. In this embodiment, calling party's telephone 402 is a conventional phone such as a mobile phone. Telephone connection or communication takes place via existing communication towers 405 and networks 406. Called party's telephone 404 includes a telephone directory 408 and the automatic scheduling or pre-arranging feature 410 disclosed in the present application. The telephone directory 408, for example, is a database of telephone numbers resident on the called party's telephone 404. The telephone 404 also includes a diary 412 of schedules that indicate called party's available times. The auto-scheduling feature 410 is, for example, a program residing in the called party's telephone 404.

As described with reference to FIG. 2, the auto scheduling feature 410 of the called party's telephone 404, when it receives a call from a caller telephone 402 and the call is not manually picked up by a person, automatically determines the identification, for example, the telephone number of the caller telephone 402 and checks if the caller telephone number is in the called party's telephone directory 408. If the caller's telephone number is in the telephone directory 408, the auto-scheduling feature 410 automatically determines the called party's next available time slot by, for instance, examining the called party's diary 412 resident in the telephone 404. The caller is then given an option to schedule the call for that available time slot. If the caller agrees to the available time slot, the auto-scheduling feature 410 schedules the call in the called party's telephone for that time. Then at the scheduled time, called party is alerted, for instance, by having the called party's telephone 404 beep, to call the caller. Alternatively, the called party's telephone 404 may be programmed to automatically dial the caller party's telephone 402 at the scheduled time.

In another embodiment, the directory 408 may be divided into separate sections, one section having a list of identifications that the telephone user would like the auto-scheduling feature 410 to automatically reschedule the calls, and another section having a list of identifications that the telephone user does not wish for automatic rescheduling of calls to occur. In this embodiment, the auto-scheduling feature 410 only reschedules for those telephone identification numbers found in the section of the directory that the telephone user would like the auto-scheduling feature 410 to automatically reschedule the calls.

FIG. 5 is a block diagram illustrating the system architecture for pre-arranging telephone connections between identifiable parties in another embodiment. In this embodiment, both caller and called parties have telephones that include the auto-scheduling feature disclosed in the present application. For example, a caller uses a telephone 502 that includes a directory 514, a diary 513, and auto-scheduling feature 512 resident in the telephone 502. The directory 514 includes a list of telephone numbers, for example, which the user of the telephone 502 knows about. The diary 513 includes the telephone user's schedule indicating the user's available times, for instance, to make telephone calls.

Similarly, a called party's telephone 504 includes a directory 508, a diary 511, and auto-scheduling feature 510 resident in the telephone 504. The directory 508 includes a list of telephone numbers, for example, which the user of the telephone 504 knows about. The diary 511 includes the telephone user's schedule indicating the user's available times, for instance, to make telephone calls. Telephone calls are made in a known conventional way, for example, via the cellular stations 505 and existing network 506.

As described with reference to FIG. 3, in this embodiment, when a call is not answered, both telephones 502 504 automatically engage in determining mutually available time slots. The caller at the telephone 502 may agree with the time slot or may opt to look for another available time slot by consulting respective diaries. When a satisfactory time slot has been found, the auto-scheduling feature 512 in the caller's telephone 502 sets up the time slot for a next call to the called party at the telephone 504. The auto-scheduling feature 512 at the caller's telephone 502 also notifies the agreed scheduled time to the auto-scheduling feature 510 of the called party's telephone 504. The auto-scheduling feature 510 of the called party's telephone 504 then schedules the call time in the called party's diary in the directory 508. At the scheduled time, the caller's telephone 502 automatically dials the called party's telephone 504. Optionally, the called party's telephone 504 may be programmed to dial the caller's telephone 502 at the scheduled time. Still yet, either party's telephones 502 504 may be programmed to alert the users at the respective telephones by, for example, beeping, so that one of the users may telephone the other user.

In one embodiment, the available time slots are determined from looking at the diary resident on the telephone. In one aspect, a user of a telephone may reserve specific time slots for returning phone calls in the diary. Further, the user may reserve specific time slots for returning phone calls to a specific caller, for instance, middle of the day, end of the day, etc. Callers may be categorized, and more time slots for returning calls may be made available for certain callers than others. Thus, different time slots may be reserved for different callers. In another aspect, a user of the telephone need not reserve any time slots, in which case, the available time slots will be determined based on first availability.

In one aspect, the disclosed auto-scheduling feature pre-arranges calling times and allows calls to be made automatically at the pre-arranged time, only if the called party recognizes the calling party's identity. Accordingly, the disclosed auto-scheduling feature effectively pre arranges convenient times for missed calls while at the same time screening out unnecessary or undesirable telephone calls.

The embodiments described above are illustrative examples and it should not be construed that the present disclosure is limited to these particular embodiments. For example, although the figures show mobile telephones, it should be understood that any personal telephones may be used in conjunction with the method and system described in the present application. Thus, various changes and modifications may be effected by one skilled in the art without departing from the spirit or scope of the invention as defined in the appended claims. Accordingly, the present invention is not limited except as by the appended claims.

1. A method of automatically pre-arranging telephone calls between identifiable parties, comprising:
receiving a telephone call from a caller;
if a called party is not available, automatically determining if the caller is recognizable; and
automatically attempting to arrange a time for a next telephone call if the caller is recognizable.

2. The method of claim 1, wherein the determining includes:
determining identification of the caller; and
checking if the identification exists in a directory resident in a telephone of the called party.

3. The method of claim 2, wherein the identification includes a telephone number of the caller.

4. The method of claim 1, wherein the automatically attempting to arrange includes:
determining an available time of the called party;
submitting the available time to the caller;
if the caller agrees, scheduling the available time in the telephone of the called party for the next telephone call.

5. The method of claim 4, further including:
alerting the called party at the scheduled time for the next telephone call.

6. The method of claim 5, wherein the alerting includes beeping the telephone of the called party.

7. The method of claim 5, wherein the alerting includes automatically calling the caller.

8. The method of claim 4, wherein the available time is determined from a called party's diary resident in the called party's telephone.

9. A method of pre-arranging telephone calls between identifiable parties, comprising:
making a telephone call using a telephone of a calling party;
if a called party is not available, determining if the called party recognizes the calling party;
if the called party recognizes the calling party, automatically communicating with a telephone of the called party to determine a mutually available time for a next call; and
if the called party recognizes the calling party, allowing a calling party to approve the mutually available time via a telephone of the calling party;
if the called party approves, scheduling the mutually available time in the telephone of the calling party for the next call;
submitting the mutually available time to the telephone of the called party; and
alerting the calling party at the scheduled time.

10. The method of claim 9, wherein the mutually available time is determined by comparing a diary of the called party and a diary of the calling party to look for a time that is available to the called party and the calling party.

11. The method of claim 10, wherein the diary of the called party is resident in the telephone of the called party and the diary of the calling party is resident in the telephone of the calling party.

12. The method of claim 9, wherein the determining if the called party recognizes the calling party includes checking a directory resident in the called party's telephone to determine if calling party's identification is in the directory.

13. The method of claim 12, wherein the calling party's identification is telephone number of the calling party.

14. The method of claim 9, further including:
automatically connecting the called party's telephone and calling party's telephone at the scheduled time.

15. The method of claim 9, wherein the called party includes a plurality of called parties.

16. The method of claim 10, wherein the diary is filled by a respective telephone user.

17. The method of claim 16, wherein the diary includes one or more time slots available for returning a phone call.

18. The method of claim 17, wherein the one or more time slots are categorized for one or more predetermined callers.

19. A system for pre-arranging a telephone connection between identifiable parties, comprising:
a directory resident in a telephone, the directory having at least one or more telephone numbers;
a diary resident in the telephone, the diary having a schedule of a user of the telephone; and
an auto-scheduling module resident in the telephone, the auto-scheduling module operable to receive a call from a caller and automatically identify the caller, and if the caller is identified as being in the directory, the auto-scheduling module operable to determine a next available time from the diary and to provide the next available time for re-scheduling the call.

20. The system of claim 19, wherein the auto-scheduling module is further operable to reschedule the call in the telephone, if the caller approves.

21. The system of claim 20, wherein the auto-scheduling module is further operable to automatically prompt a user of the telephone at the rescheduled time.

22. The system of claim 20, wherein the auto-scheduling module is further operable to automatically make a telephone call to the caller at the rescheduled time.

23. The system of claim 20, wherein the auto-scheduling module is further operable to block other incoming calls for a predetermined period of time before and after the rescheduled time.

24. The system of claim 20, wherein the auto-scheduling module is further operable to provide a warning if a call is attempted to be made during a predetermined period of time before and after the rescheduled time.

25. The system of claim 19, wherein the directory is separated into a plurality of sections, at least one of the plurality of sections having a list of identifications permitted for automatic rescheduling of calls, at least another one of the plurality of sections having a list of identifications not permitted for automatic rescheduling of calls.

26. A program storage device readable by machine, tangibly embodying a program of instructions executable by the machine to perform method of automatically pre-arranging telephone calls between identifiable parties, comprising:
receiving a telephone call from a caller;
if a called party is not available, automatically determining if the caller is recognizable; and
automatically attempting to arrange a time for a next telephone call if the caller is recognizable.

27. The program storage device of claim 26, wherein the determining includes:
determining identification of the caller; and
checking if the identification exists in a directory resident in a telephone of the called party.

28. The program storage device of claim 26, wherein the automatically attempting to arrange includes:
determining an available time of the called party;
submitting the available time to the caller;
if the caller agrees, scheduling the available time in the telephone of the called party for the next telephone call.

29. The program storage device of claim 28, wherein the available time is determined from a called party's diary resident in the called party's telephone.

30. The system of claim 19, wherein the diary further includes at least one or more time blocks reserved for re-scheduling missed calls.

31. The system of claim 30, wherein the one or more time blocks are allocated by a user of the telephone.
